(19) United States
(12) Patent Application Publication
(10) Pub. No.: US 2007/0139355 A1
(43) Pub. Date: Jun. 21, 2007

(54) Display device and automobile having the same

(75) Inventors: Kentaro Ryuh, Tenri-shi, Nara (JP); Koji Ueno, Shiki-gun, Nara (JP); Hidetaka Mizumaki, Nara-shi, Nara (JP)

Correspondence Address: SHARP KABUSHIKI KAISHA;C/O KEATING & BENNETT, LLP, 8180 GREENSBORO DRIVE, SUITE 850, MCLEAN, VA, 22102, US

(73) Assignee: SHARP KABUSHIKI KAISHA, Osaka-shi, Osaka (JP)

(21) Appl. No.: 10/598,029

(22) PCT Filed: Feb. 14, 2005
(86) PCT No.: PCT/JP05/02130

§ 371 Date: Aug. 16, 2006

(30) Foreign Application Priority Data
Feb. 17, 2004 (JP) 2004-039593

(51) Int. Cl. G09G 3/36

(52) U.S. Cl. 345/103

(57) ABSTRACT

There are provided a display device which consumes little power and which is suitable for displaying multiple contents, and an automotive vehicle having the same. The display device according to the present invention includes a display panel having a first display section and a second display section, and driving circuitry for driving the display panel. The driving circuitry includes a first scanning line driving circuit for supplying a scanning signal to scanning line of the first display section, a first signal line driving circuit for supplying a data signal to signal lines of the first display section, a second scanning line driving circuit for supplying a scanning signal to scanning lines of the second display section, and a second signal line driving circuit for supplying a data signal for signal lines of the second display section. The driving circuitry is capable of driving the first display section and the second display section with different vertical scanning frequencies.

### TECHNICAL FIELD

The present invention relates to a display device and an automotive vehicle having the same. In particular, the present invention relates to an active matrix-type display device and an automotive vehicle having the same.

### BACKGROUND ART

In recent years, liquid crystal display devices have been used in OA devices such as personal computers and AV devices such as camcorders, on the strength of being thin and consuming little power. In particular, active matrix-type liquid crystal display devices are in wide use because they are capable of performing display with a high resolution.

Referring to FIG. 5, the structure of a conventional active matrix-type liquid crystal display device 500 will be described.

As shown in FIG. 5, the liquid crystal display device 500 includes a display panel 510 and driving circuitry 520 for driving the display panel 510. The display panel 510 includes: a plurality of scanning lines (gate lines) 2 which are disposed parallel to one another; a plurality of signal lines (source lines) 4 which are disposed parallel to one another along a direction intersecting the plurality of scanning lines 2; a plurality of TFTs (thin film transistors) 6, each of which is connected to one of the scanning lines 2 and one of the signal lines 4; and a plurality of pixel capacitors 8, each of which is connected to one TFT.

Each pixel capacitor 8 is constituted by a liquid crystal capacitor and a storage capacitor which is provided in parallel thereto, for example. The plurality of pixel capacitors are arranged in a matrix shape, each of which corresponds to a pixel of the display panel. A liquid crystal capacitor is composed of, for example: a pixel electrode which is formed on an active matrix substrate having the scanning lines 2, the signal lines 4, and the TFTs 6 formed thereon; a counter electrode which is provided on a counter substrate that opposes the active matrix substrate, so as to oppose the pixel electrode; and a liquid crystal layer between the pixel electrode and the counter electrode.

The driving circuitry 520 includes: a scanning line driving circuit 22 for supplying scanning signals to the scanning lines 2; and a signal line driving circuit 24 for supplying data signals to the signal lines. Based on a scanning signal which is supplied from the scanning line driving circuit 22, the TFTs 6 which are connected to a selected one among the plurality of scanning lines 2 become active, and at this time, a data signal which is supplied from the signal line driving circuit 24 is written to the pixels (i.e., the pixel capacitors 8 which are connected to the active TFTs 6) via the signal lines 4. By performing this operation for all scanning lines, an image displaying is performed.

Recently, use of liquid crystal display devices as large-size television sets is being promoted. In the conventional active matrix-type liquid crystal display device 500 as shown in FIG. 5, there is a problem in that display unevenness occurs as the size of the display panel 510 becomes larger. Such display unevenness is ascribable to the scanning signal supplied from the scanning line driving circuit 22 being delayed or undergoing waveform blunting due to the wiring resistance and parasitic capacitance of the scanning lines 2.

In order to solve this problem, Patent Document 1 and Patent Document 2 disclose a method of providing two scanning line driving circuits.

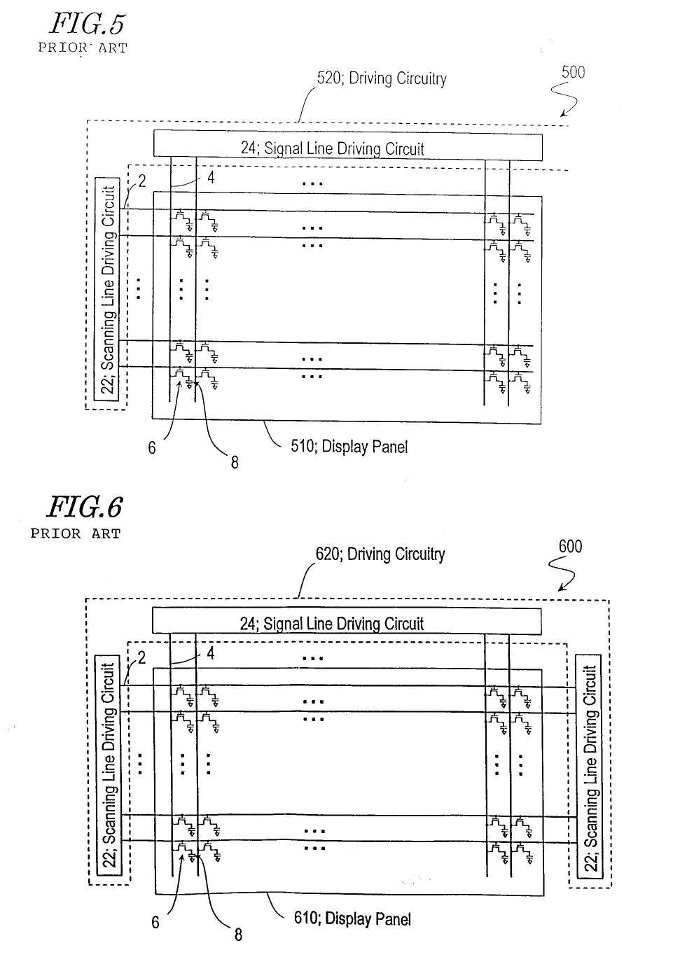

FIG. 6 shows a liquid crystal display device 600 which is disclosed in Patent Document 1. Driving circuitry 620 comprised in the liquid crystal display device 600 has two scanning line driving circuits 22, which are provided on the right side and the left side of a display panel 610, so that scanning signals are input to scanning lines 2 not only from one side but from both sides thereof. As a result, the signal delay and waveform blunting ascribable to the wiring resistance and parasitic capacitance of the scanning lines 2 are suppressed, whereby display unevenness is suppressed.

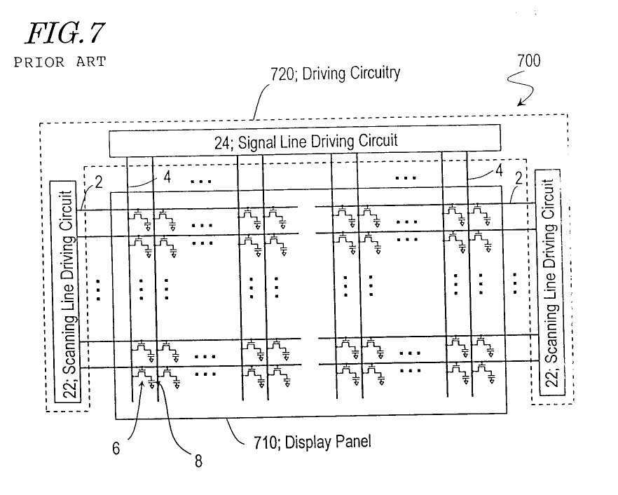

FIG. 7 shows a liquid crystal display device 700 which is disclosed in Patent Document 2. Driving circuitry 720 comprised in the liquid crystal display device 700 has two scanning line driving circuits 22, which are provided on the right side and the left side of a display panel 710. Scanning lines 2 of the display panel 710 are split near the center of the display panel 710. Thus, scanning signals are input from the right-side scanning line driving circuit 22 to the right-side scanning lines 2, whereas scanning signals are input from the left-side scanning line driving circuit 22 to the left-side scanning lines 2. Therefore, as in the liquid crystal display device 600, signal delay and waveform blunting are suppressed, whereby display unevenness is suppressed.

[Patent Document 1] Japanese Laid-Open Utility Model Publication No. 64-40823

[Patent Document 2] Japanese Laid-Open Patent Publication No. 2002-23683

### DISCLOSURE OF INVENTION

Problems to be Solved by the Invention

However, in recent years, use of liquid crystal display devices for various products has been promoted, and there is a need, not only for prevention of display unevenness, but also further reduction of power consumption, a function of allowing a plurality of pieces of information to be simultaneously displayed (multiple contents display), and the like.

The present invention has been made in view of the above problems, and an objective thereof is to provide a display device which consumes little power and which is suitable for displaying multiple contents, and an automotive vehicle having the same.

Means for Solving the Problems

The display device according to the present invention is a display device comprising a display panel and driving circuitry for driving the display panel, wherein, the display panel includes a first display section and a second display section; the first display section includes a plurality of first scanning lines, a plurality of first signal lines, a plurality of first switching elements each connected to one of the plurality of first scanning lines and one of the plurality of first signal lines, and a plurality of first pixels each connected to one of the plurality of first switching elements; the second display section includes a plurality of second scanning lines, a plurality of second signal lines, a plurality of second switching elements each connected to one of the plurality of second scanning lines and one of the plurality of second signal lines, and a plurality of second pixels each connected to one of the plurality of second switching elements; and the driving circuitry includes a first scanning line driving circuit for supplying a first scanning signal to the plurality of first scanning lines, a first signal line driving circuit for supplying a first data signal to the plurality of first signal lines, a second scanning line driving circuit for supplying a second scanning signal to the plurality of second scanning lines, and a second signal line driving circuit for supplying a second data signal for the plurality of second signal lines, the driving circuitry being capable of driving the first display section with a first vertical scanning frequency and driving the second display section with a second vertical scanning frequency which is different from the first vertical scanning frequency. Thus, the aforementioned objective is met.

In a preferred embodiment, the first vertical scanning frequency and the second vertical scanning frequency are set in accordance with types of information which are respectively displayed on the first display section and the second display section.

In a preferred embodiment, the display panel is a liquid crystal display panel having a pair of substrates and a liquid crystal layer provided between the pair of substrates.

In a preferred embodiment, during one vertical scanning period, the first signal line driving circuit supplies a first black display signal to the plurality of first pixels with a different timing from a timing of supplying the first data signal, the first black display signal corresponding to displaying black; and for a predetermined first length of time within the length of time corresponding to one vertical scanning period, the plurality of first pixels are placed in a state of retaining the first data signal, and for a predetermined second length of time, the plurality of first pixels are placed in a state of retaining the first black display signal.

In a preferred embodiment, during one vertical scanning period, the second signal line driving circuit supplies a second black display signal to the plurality of second pixels with a different timing from a timing of supplying the second data signal, the second black display signal corresponding to displaying black; and for a predetermined third length of time within the length of time corresponding to one vertical scanning period, the plurality of second pixels are placed in a state of retaining the second data signal, and for a predetermined fourth length of time, the plurality of second pixels are placed in a state of retaining the second black display signal.

In a preferred embodiment, the display device according to the present invention is a display device for an instrument panel mounted in an automotive vehicle.

In a preferred embodiment, the first display section displays at least a velocity of the automotive vehicle and/or a number of revolutions of an engine of the automotive vehicle; and the first vertical scanning frequency is higher than the second vertical scanning frequency.

In a preferred embodiment, the display panel includes a touch sensor selectively provided in one of the first display section and the second display section.

In a preferred embodiment, at least a portion of the driving circuitry is formed directly on a substrate of the display panel.

An automotive vehicle according to the present invention comprises an instrument panel which includes a display device of the above construction. Thus, the aforementioned objective is met.

Effects of the Invention

In the display device according to the present invention, the display panel includes a first display section and a second display section. Therefore, the scanning lines can be made shorter than in a construction where the display panel includes only one display section. As a result, delaying of scanning signals and waveform blunting ascribable to the wiring resistance and parasitic capacitance of the scanning lines can be suppressed, and display unevenness can be suppressed. Moreover, the display device according to the present invention includes a scanning line driving circuit and a signal line driving circuit for each of the first display section and the second display section of the display panel, and therefore different pieces of information can be displayed on the first display section and the second display section, thus making it possible to simultaneously display a plurality of pieces of information. Furthermore, the driving circuitry is capable of driving the first display section and the second display section with different vertical scanning frequencies. Therefore, by ensuring that one of the vertical scanning frequencies is relatively low, low power consumption can be realized. Moreover, since the display device according to the present invention includes a scanning line driving circuit and a signal line driving circuit for each of the first display section and the second display section, it is also possible to drive the first display section and the second display section by different driving methods. Therefore, each of the first display section and the second display section can be driven by a driving method which is optimum for the information that is displayed thereon, whereby a plurality of pieces of information can be displayed simultaneously and in suitable manners.

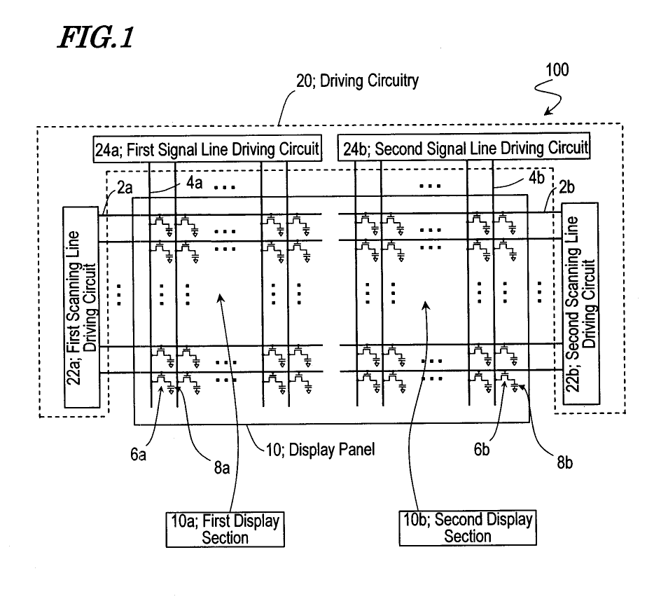

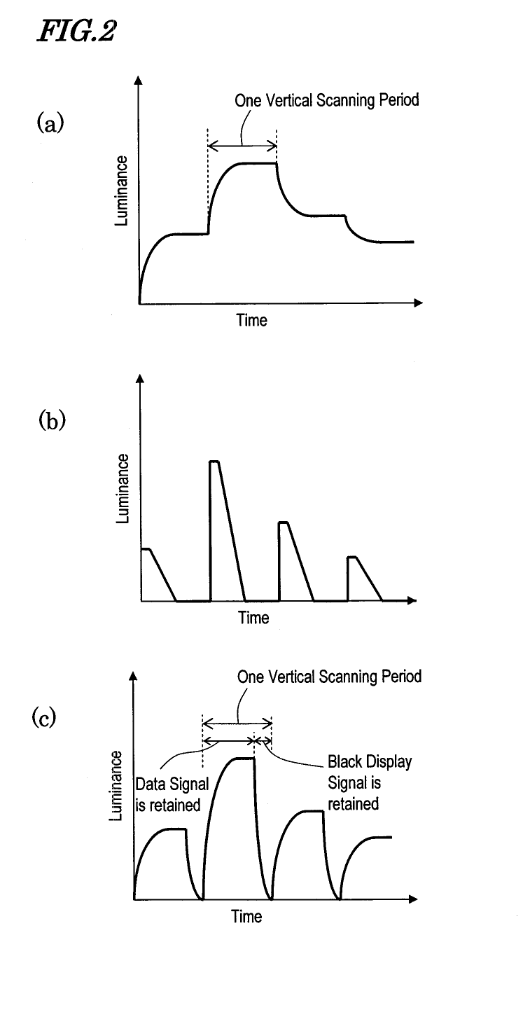

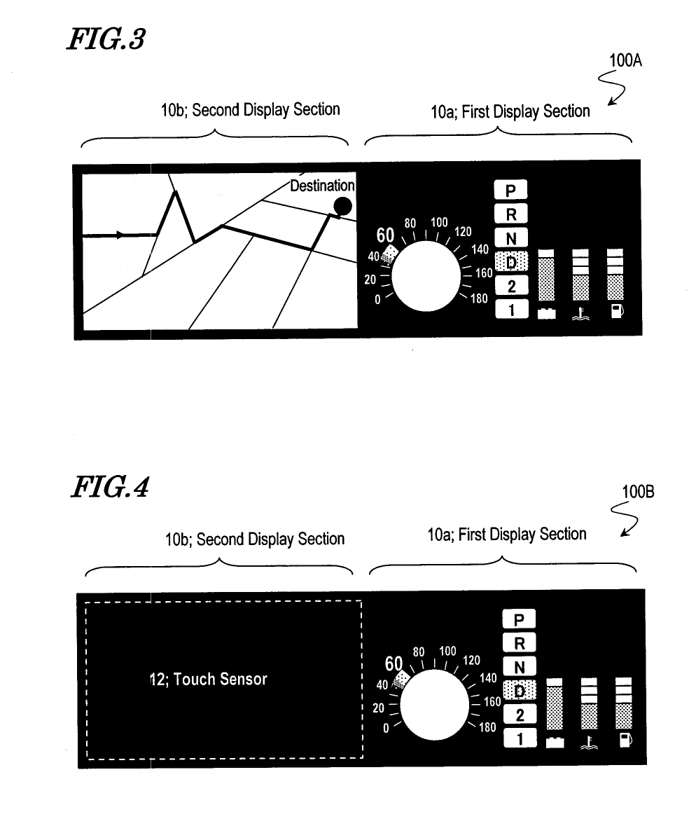

### BRIEF DESCRIPTION OF DRAWINGS

[FIG. 1] A diagram schematically showing a liquid crystal display device according to the present invention.

[FIG. 2] (a) is a graph showing changes over time in the luminance of a liquid crystal display device which performs a hold-type display; (b) is a graph showing changes over time in the luminance of a CRT which performs an impulse-type display; and (c) is a graph showing changes over time in the luminance of a liquid crystal display device which performs black insertion driving (pseudo-impulse driving).

[FIG. 3] A diagram showing an implementation in which a liquid crystal display device according to the present invention is used as a display device for an instrument panel which is mounted in an automotive vehicle.

[FIG. 4] A diagram showing another implementation in which a liquid crystal display device according to the present invention is used as a display device for an instrument panel which is mounted in an automotive vehicle.

[FIG. 5] A diagram schematically showing a conventional active matrix-type liquid crystal display device.

[FIG. 6] A diagram schematically showing a conventional active matrix-type liquid crystal display device.

[FIG. 7] A diagram schematically showing a conventional active matrix-type liquid crystal display device.

### DESCRIPTION OF THE REFERENCE NUMERALS

2a first scanning line

2b second scanning line

4a first signal line

4b second signal line

6a first TFT

6b second TFT

8a first pixel capacitor

8b second pixel capacitor

10 display panel

10a first display section

10b second display section

12 touch sensor

20 driving circuitry

22a first scanning line driving circuit

22b second scanning line driving circuit

24a first signal line driving circuit

24b second signal line driving circuit

100, 100A, 100B liquid crystal display device

### BEST MODE FOR CARRYING OUT THE INVENTION

Hereinafter, an embodiment of the present invention will be described with reference to drawings. Note that the present invention is not to be limited to the following embodiment.

FIG. 1 schematically shows the construction of a liquid crystal display device 100 according to the present embodiment. As shown in FIG. 1, the liquid crystal display device 100 includes a display panel 10 and driving circuitry 20 for driving the display panel 10.

The display panel 10 includes a first display section 10a and a second display section 10b. In the present embodiment, the first display section 10a and the second display section 10b have substantially the same size as each other, and are disposed along the horizontal direction.

The first display section 10a includes: a plurality of first scanning lines 2a which are disposed parallel to one another; a plurality of first signal lines 4a which are disposed parallel to one another along a direction intersecting the first scanning lines 2a; a plurality of first TFTs (thin film transistors) 6a, each of which is connected to one of the plurality of first scanning lines 2a and one of the plurality of first signal lines 4a; and a plurality of first pixel capacitors 8a, each of which is connected to one of the plurality of first TFTs 6a.

The second display section 10b includes: a plurality of second scanning lines 2b which are disposed parallel to one another; a plurality of second signal lines 4b which are disposed parallel to one another along a direction intersecting the second scanning lines 2b; a plurality of second TFTs 6b, each of which is connected to one of the plurality of second scanning lines 2b and one of the plurality of second signal lines 4b; and a plurality of second pixel capacitors 8b, each of which is connected to one of the plurality of second TFTs 6b.

Each of the first pixel capacitors 8a and the second pixel capacitors 8b is constituted by a liquid crystal capacitor and a storage capacitor which is provided in parallel thereto, for example. The plurality of first pixel capacitors 8a and the plurality of second pixel capacitors 8b are arranged in a matrix shape, each of which corresponds to a pixel of the display panel. The pixels corresponding to the first pixel capacitors 8a will be referred to as “first pixels” of the first display section 10a, whereas the pixels corresponding to the second pixel capacitors 8b will be referred to as “second pixels” of the second display section 10b. A liquid crystal capacitor is composed of, for example: a pixel electrode which is formed on an active matrix substrate; a counter electrode which is provided on a counter substrate that opposes the active matrix substrate, so as to oppose the pixel electrode; and a liquid crystal layer between the pixel electrode and the counter electrode (none of which is shown). Note that the pair of electrodes for applying a voltage across the liquid crystal layer do not need to be provided on different substrates, but may be provided on the same substrate, as in the IPS (In-Plane Switching) method. Moreover, for ease of understanding, FIG. 1 illustrates there being wide interspaces between the pixels at the right end of the first display section 10a and the pixels at the left end of the second display section 10b. However, these interspaces are typically equal to the pixel pitch(es) within the respective display sections.

The driving circuitry 20 includes: a first scanning line driving circuit 22a for supplying scanning signals to the first scanning lines 2a; a first signal line driving circuit 24a for supplying data signals to the first signal lines 4a; a second scanning line driving circuit 22b for supplying scanning signals to the second scanning lines 2b; and a second signal line driving circuit 24b for supplying data signals to the second signal lines 4b. Thus, the first display section 10a and the second display section 10b can be driven with different vertical scanning frequencies. A “vertical scanning frequency” represents the number of times the entire screen of the display section is updated in one second, and is also referred to as a refresh rate.

As described above, in the liquid crystal display device 100 according to the present invention, the display panel 100 includes the first display section 10a and the second display section 10b. Therefore, the scanning lines can be made shorter than in a construction where the display panel includes only one display section. For example, as in the present embodiment, by disposing the display sections 10a and 10b which have substantially the same size along the horizontal direction (i.e., the direction along which the scanning lines extend), the length of the scanning lines can be reduced to about half. As a result, delaying of scanning signals and waveform blunting ascribable to the wiring resistance and parasitic capacitance of the scanning lines can be suppressed, and display unevenness can be suppressed.

Moreover, the liquid crystal display device 100 includes a scanning line driving circuit and a signal line driving circuit for each of the first display section 10a and the second display section 10b of the display panel 10, and therefore different pieces of information can be displayed on the first display section 10a and the second display section 10b, thus making it possible to simultaneously display a plurality of pieces of information. It will also be appreciated that the first display section 10a and the second display section 10b may display a single piece of information in a cooperative manner. For example, the first display section 10a and the second display section 10b may cooperatively display a single image.

Furthermore, the driving circuitry 20 comprised in the liquid crystal display device 100 is capable of driving the first display section 10a and the second display section 10b with different vertical scanning frequencies. Therefore, by setting vertical scanning frequencies in accordance with the respective types of information displayed on the first display section 10a and the second display section 10b, low power consumption can be realized. For example, in the case where a still picture is displayed, there will be no displaying problems even if driving is performed with a vertical scanning frequency which is lower than that used for displaying moving pictures. Therefore, when moving pictures are displayed on the first display section 10a and a still picture is displayed on the second display section 10b, the vertical scanning frequency of the second display section 10b may be made lower (e.g., 10 Hz) than the vertical scanning frequency (e.g., 60 Hz) of the first display section 10a, whereby power consumption can be reduced because of the second display section 10b being driven with a low vertical scanning frequency.

Note that, in order to drive the first display section 10a and the second display section 10b with different vertical scanning frequencies, the frequencies of various control signals (including a clock signal) to be input to the first scanning line driving circuit 22a and the first signal line driving circuit 24a may be made different from the frequencies of various control signals which are input to the second scanning line driving circuit 22b and the second signal line driving circuit 24b.

Moreover, since the liquid crystal display device 100 includes a scanning line driving circuit and a signal line driving circuit for each of the first display section 10a and the second display section 10b of the display panel 10, it is also possible to drive the first display section 10a and the second display section 10b by different driving methods. Therefore, each of the first display section 10a and the second display section 10b can be driven by a driving method which is optimum for the information that is displayed thereon, whereby a plurality of pieces of information can be displayed simultaneously and in suitable manners.

For example, when moving pictures are displayed on the first display section 10a and a still picture is displayed on the second display section 10b, so-called “black insertion driving” may be performed in the first display section 10a, while performing usual driving in the second display section 10b. “Black insertion driving” is a driving method, used in a liquid crystal display device which basically performs a hold-type display, for performing an impulse-type display similar to that of a CRT, and is also referred to as “pseudo-impulse driving”. By performing black insertion driving, persistence of vision and blurring of moving pictures can be suppressed.

Hereinafter, black insertion driving will be more specifically described with reference to (a) to (c) of FIG. 2.

As shown in FIG. 2(a), a commonly-used liquid crystal display device performs a hold-type display, where a luminance corresponding to a data signal which is written in a given vertical scanning period lasts until a new data signal is written in a next vertical scanning period. On the other hand, as shown in FIG. 2(b), a CRT performs an impulse-type display, where light emission occurs only during a partial length of time during one vertical scanning period. Note that one vertical scanning period corresponds to one frame in the case of non-interlace driving, and one field in the case of interlace driving where one frame is divided into a plurality of fields.

In the case of performing black insertion driving in the first display section 10a, during one vertical scanning period, a black display signal corresponding to displaying black is supplied from the first signal line driving circuit 24a to the first pixels, with a timing which is different from the timing of supplying the data signal. Thus, for a predetermined length of time within the length of time corresponding to one vertical scanning period, the first pixels are placed in a state of retaining the data signal, and for a predetermined length of time within the remaining length of time, the first pixels are placed in a state of retaining the black display signal. In this manner, as shown in FIG. 2(c), a pseudo impulse-type display can be performed, whereby persistence of vision and blurring of moving pictures can be suppressed.

The proportion between the length of time during which the data signal is retained and the length of time during which the black display signal is retained may be appropriately set, in accordance with the vertical scanning frequency, the type of information to be displayed, the purpose of the liquid crystal display device, and the like. From the perspective of sufficiently suppressing persistence of vision and blurring of moving pictures, it is preferable that the length of time during which the black display signal is retained accounts for ¼ or more of the length of time corresponding to one vertical scanning period.

Note that, although FIG. 2(c) illustrates a case where the luminance lowers to a black displaying state within the length of time during which the black display signal is retained, it is not necessary for the luminance to be lowered to a black displaying state within the length of time during which the black display signal is retained. The luminance may not be sufficiently lowered and a strictly black displaying state may not be obtained in the case where: the length of time for writing the black display signal (i.e., the length of time during which the TFTs are active in a write of the black display signal) is short; the response speed of the liquid crystal layer is slow; or the length of time during which the black display signal is retained is short. However, even in such cases, it is possible to obtain the effects of pseudo-impulse driving.

As specific methods of black insertion driving, known methods can be broadly used. By employing the methods disclosed in Japanese Laid-Open Patent Publication No. 2001-60078 and Japanese Laid-Open Patent Publication No. 2001-296838, black insertion driving can be performed with a simple construction.

Moreover, as disclosed in Japanese Laid-Open Patent Publication No. 2001-60078, a construction may be adopted where a signal which is different from the black display signal as a data signal (i.e., the lowest gray-scale level signal) can be generated as a black display signal for performing black insertion driving. As a result, it becomes possible to apply a voltage which is higher (or lower) than the voltage corresponding to the lowest gray scale signal across the liquid crystal layer, whereby the response speed of the liquid crystal layer when writing a black display signal can be improved, and the luminance can be promptly brought down to the black displaying state within the length of time during which the black display signal is retained. Therefore, the effects of suppressing persistence of vision and blurring of moving pictures can be adequately obtained.

Although a case has been illustrated where only the first display section 10a is subjected to black insertion driving, black insertion driving may be performed in both the first display section 10a and the second display section 10b, for example in the case where moving pictures are displayed in both the first display section 10a and the second display section 10b. In that case, the length of time during which the black display signal is to be retained within the length of time corresponding to one vertical scanning period, and the proportion thereof, may be differentiated between the first display section 10a and the second display section 10b in accordance with the vertical scanning frequencies of the respective display sections and the like.

The display device according to the present invention can be suitably used as a display device for an instrument panel which is mounted in an automotive vehicle. An instrument panel is a console on which information (e.g., velocity) that is necessary for driving an automotive vehicle is displayed. An instrument panel is often shaped so that its width along the right-left (horizontal) direction is much wider than its width along the up-down (vertical) direction. However, as described above, the display device according to the present invention includes a plurality of display sections which can be separately driven, and therefore when used for an instrument panel, makes it possible to perform displaying while suppressing unevenness ascribable to signal delay and waveform blunting. As used herein, an “automotive vehicle” may be any vehicle or machine which is capable of self propulsion and broadly refer to passenger or article transportation or moving of objects, e.g., a car, a motorbike, a bus, a truck, a tractor, an airplane, a motorboat, a vehicle for civil engineering use, a train, or the like. It will be appreciated that “automotive vehicles” are not limited to only those which are provided with internal combustion engines such as gasoline engines as their engines, but also encompass those provided with motors (so-called electric motors).

Referring to FIG. 3, an example where the display device according to the present invention is used for an instrument panel will be described. FIG. 3 is a diagram schematically showing a liquid crystal display device 100A for an instrument panel which is mounted in a four-wheeled automobile.

The liquid crystal display device 100A basically has the same construction as that of the liquid crystal display device 100 shown in FIG. 1, and includes a first display section 10a and a second display section 10b. FIG. 3 illustrates an example where the velocity of the automotive vehicle, shift lever position, remaining battery power, water temperature, and fuel remaining amount are displayed on the first display section 10a, while car navigation information for informing the traveling driver of the current location and routes to a destination is displayed on the second display section 10b.

In the case where different pieces of information are to be displayed on the first display section 10a and the second display section 10b, it is not necessary to update both display sections with the same refresh rate. In the example shown in FIG. 3, it is preferable to update the first display section 10a for displaying information including velocity with a high refresh rate, but it would not be problematic to update the second display section 10b for displaying car navigation information with a low refresh rate. According to the present invention, since the first display section 10a and the second display section 10b can be driven with different vertical scanning frequencies (refresh rates), the vertical scanning frequency of the first display section 10a for displaying velocity may be set relatively high, and the vertical scanning frequency of the second display section 10b may be set relatively low, whereby the power consumption can be reduced.

Moreover, the first display section 10a for displaying velocity is required to have a better moving-picture displaying performance than is the second display section 10b for displaying car navigation information. According to the present invention, since the first display section 10a and the second display section 10b can be driven by different driving methods, it is possible to perform black insertion driving for the first display section 10a for displaying velocity, while performing usual driving for the second display section 10b for displaying car navigation information, whereby velocity displaying can be performed without persistence of vision or blurring.

The number of revolutions of the engine (a gasoline engine or an electric motor) is not displayed on the first display section 10a in FIG. 3. Note that, even in the case where the number of revolutions is displayed, it is preferable to perform updates with a high refresh rate and perform black insertion driving, as in the case of displaying velocity.

FIG. 4 schematically shows another liquid crystal display device 100B for an instrument panel. The liquid crystal display device 100B differs from the liquid crystal display device 100A in that it includes a touch sensor 12 which is selectively provided in the second display section 10b.

In the liquid crystal display device 100B, since the touch sensor 12 is provided in the second display section 10b as shown in FIG. 4, it is possible to perform various input operations by touching the second display section 10b. Therefore, without taking his or her line of sight off the instrument panel, the driver is able to perform various operations more safely and with a greater certainty.

As the touch sensor 12, various known types of touch sensors can be used. For example, resistive film-type or capacitance-type touch sensors can be suitably used.

Moreover, the driving circuitry 20 for driving the display panel 10 may be formed on a substrate (e.g., a flexible substrate) which is different from the substrate of the display panel 10, or may be directly formed on the substrate of the display panel 10 (e.g., an active matrix substrate). By forming at least part of the driving circuitry 20 directly on the substrate of the display panel 10, the display device can be made even thinner.

### INDUSTRIAL APPLICABILITY

According to the present invention, a display device which consumes little power and which is suitable for displaying multiple contents is provided. The present invention is particularly suitably used for a display device for an instrument panel which is mounted in an automotive vehicle.

1. A display device comprising a display panel and driving circuitry for driving the display panel, wherein,
the display panel includes a first display section and a second display section;
the first display section includes a plurality of first scanning lines, a plurality of first signal lines, a plurality of first switching elements each connected to one of the plurality of first scanning lines and one of the plurality of first signal lines, and a plurality of first pixels each connected to one of the plurality of first switching elements;
the second display section includes a plurality of second scanning lines, a plurality of second signal lines, a plurality of second switching elements each connected to one of the plurality of second scanning lines and one of the plurality of second signal lines, and a plurality of second pixels each connected to one of the plurality of second switching elements; and
the driving circuitry includes a first scanning line driving circuit for supplying a first scanning signal to the plurality of first scanning lines, a first signal line driving circuit for supplying a first data signal to the plurality of first signal lines, a second scanning line driving circuit for supplying a second scanning signal to the plurality of second scanning lines, and a second signal line driving circuit for supplying a second data signal for the plurality of second signal lines, the driving circuitry being capable of driving the first display section with a first vertical scanning frequency and driving the second display section with a second vertical scanning frequency which is different from the first vertical scanning frequency.

2. The display device of claim 1, wherein the first vertical scanning frequency and the second vertical scanning frequency are set in accordance with types of information which are respectively displayed on the first display section and the second display section.

3. The display device of claim 1, wherein the display panel is a liquid crystal display panel having a pair of substrates and a liquid crystal layer provided between the pair of substrates.

4. The display device of claim 3, wherein,
during one vertical scanning period, the first signal line driving circuit supplies a first black display signal to the plurality of first pixels with a different timing from a timing of supplying the first data signal, the first black display signal corresponding to displaying black; and
for a predetermined first length of time within the length of time corresponding to one vertical scanning period, the plurality of first pixels are placed in a state of retaining the first data signal, and for a predetermined second length of time, the plurality of first pixels are placed in a state of retaining the first black display signal.

5. The display device of claim 4, wherein,
during one vertical scanning period, the second signal line driving circuit supplies a second black display signal to the plurality of second pixels with a different timing from a timing of supplying the second data signal, the second black display signal corresponding to displaying black; and
for a predetermined third length of time within the length of time corresponding to one vertical scanning period, the plurality of second pixels are placed in a state of retaining the second data signal, and for a predetermined fourth length of time, the plurality of second pixels are placed in a state of retaining the second black display signal.

6. The display device of claim 1 which is a display device for an instrument panel mounted in an automotive vehicle.

7. The display device of claim 6, wherein,
the first display section displays at least a velocity of the automotive vehicle and/or a number of revolutions of an engine of the automotive vehicle; and
the first vertical scanning frequency is higher than the second vertical scanning frequency.

8. The display device of claim 6, wherein the display panel includes a touch sensor selectively provided in one of the first display section and the second display section.

9. The display device of claim 1, wherein at least a portion of the driving circuitry is formed directly on a substrate of the display panel.

10. An automotive vehicle comprising an instrument panel which includes the display device of claim 6.
